(19) United States
(12) Patent Application Publication
(10) Pub. No.: US 2015/0252162 A1
(43) Pub. Date: Sep. 10, 2015

(54) ANTI-MICROBIAL MODIFIED MATERIAL AND ANTI-MICROBIAL MODIFICATION METHOD

(71) Applicant: National Taiwan University, Taipei (TW)

(72) Inventors: Hsien-Yeh Chen, Taipei (TW); Chih-Hao Chang, Taipei City (TW); Che-Wei Hsu, Taipei (TW); Ting-Ju Lin, Taipei (TW); Shu-Yun Yeh, Taipei (TW)

(21) Appl. No.: 14/327,575

(22) Filed: Jul. 10, 2014

(30) Foreign Application Priority Data
Mar. 5, 2014 (TW) 103107464

(51) Int. Cl. C08J 7/12; B05D 3/06; B05D 1/00

(52) U.S. Cl. CPC C08J 7/12; B05D 1/60; B05D 3/06; B05D 1/005; C08J 2365/04

(57) ABSTRACT

The present invention concerns an anti-microbial modified material and an anti-microbial modification method, obtained by a bonding of a compound represented by formula (I) with a benzoyl-containing photoinitiator via a photoreaction. For the substrate surface modified by the anti-microbial modification method of the invention, the formation of the biofilm can be drastically diminished and a strong bactericidal capability may be afforded.

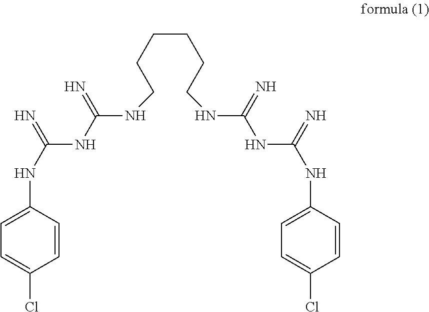 [SMILES: N=C(NCCCCCCNC(=N)NC(=N)Nc1ccc(Cl)cc1)NC(=N)Nc1ccc(Cl)cc1]

### CROSS-REFERENCE TO RELATED APPLICATION

This application claims the priority benefit of Taiwan application serial no. 103107464, filed on Mar. 5, 2014. The entirety of the above-mentioned patent application is hereby incorporated by reference herein and made a part of this specification.

### BACKGROUND OF THE INVENTION

1. Field of the Invention

The present invention generally relates to a modified material and a modification method, and more particularly, to an anti-microbial modified material compatible with a variety of substrates for anti-microbial modification and an anti-microbial modification method.

2. Description of Related Art

As the technology in the therapeutic medicine field advances rapidly and the surface modification technology progresses promptly, the functions and utilities of the biomedical materials have gradually upgraded from meeting the demands of mostly mechanical properties into further satisfying the biological functionality. For the conventional biomedical materials, considerable progresses have been achieved in aspects of materials, surgical techniques and mechanical strength. However, many challenges remain in solving infection problems caused by the implantation of the biomedical materials. This type of infection can easily cause necrosis of the tissues around the implantation site and cause the biomedical materials or devices to lose functionality. The cause for the infection after the implantation of biomedical materials may be on-site proliferation of bacteria attached to the biomedical materials. In terms of infection, once the bacteria are attached on the surface of the biomedical material, colonization of the bacteria would occur, when the concentration of antibiotics is insufficient, and a biofilm would be formed. At this point, even the strongest antibiotics would be ineffective.

Currently, one of the most common solutions is to apply anti-microbial substances for surface modification of the biomedical material(s) to exert anti-microbial or even bactericidal function, thereby lowering the possibility of infection. However, different modification techniques are required for different materials and no common modification technique is commonly applicable for various materials. In addition, these modification methods usually performed in high temperature environments and with metal catalysts and/or toxic solvents are unsafe. The application of anti-microbial substances for surface modification may cause toxic stimulation and allergic reactions to the body as the anti-microbial substances may be released to the nearby environment. Therefore, it is desirable to develop an anti-microbial modification method with high safety in the field of biomedicine and universal applicability.

### SUMMARY OF THE INVENTION

The invention provides an anti-microbial modified material compatible with a variety of substrates. The anti-microbial modified material may be formed on the substrate surface to exert anti-microbial function on the modified surface of the substrate.

The invention also provides an anti-microbial modified material having specific structural unit(s) and with an antimicrobial effect. The anti-microbial modified material can be used on a variety of substrates for anti-microbial surface modification.

The invention further provides an anti-microbial modification method capable of simply and safely modifying the surface of various substrates for anti-microbial functions.

The anti-microbial modified material of the invention is obtained by a bonding of a compound represented by formula (1) and a benzoyl-containing photoinitiator via a photoreaction,

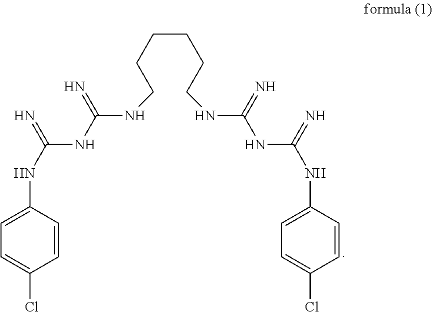 [SMILES: N=C(NCCCCCCNC(=N)NC(=N)Nc1ccc(Cl)cc1)NC(=N)Nc1ccc(Cl)cc1]

In an embodiment of the invention, the benzoyl-containing photoinitiator includes poly(4-benzoyl-p-xylylene-co-p-xylylene).

In an embodiment of the invention, the bonding is chemical covalent bonding.

In an embodiment of the invention, a wavelength of irradiation light of the photoreaction ranges from 350 nm to 380 nm.

In an embodiment of the invention, an irradiation time of irradiation light of the photoreaction ranges from 5 minutes to 120 minutes.

In an embodiment of the invention, a light intensity of irradiation light of the photoreaction ranges from 50 mW/cm² to 10000 mW/cm².

Another anti-microbial modified material of the invention includes a structural unit shown in formula (2):

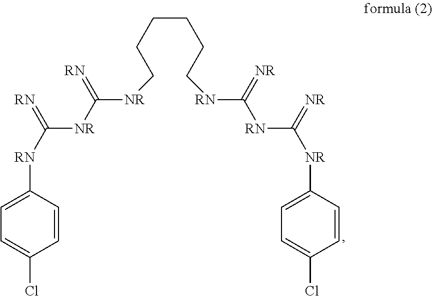

in formula (2), R may each independently represents hydrogen or —C(—OH)(-Ph)-, and at least one R is —C(—OH)(-Ph)-.

In another embodiment of the invention, at least one R in formula (2) is hydrogen.

In another embodiment of the invention, the anti-microbial modified material is a structural unit shown in formula (5):

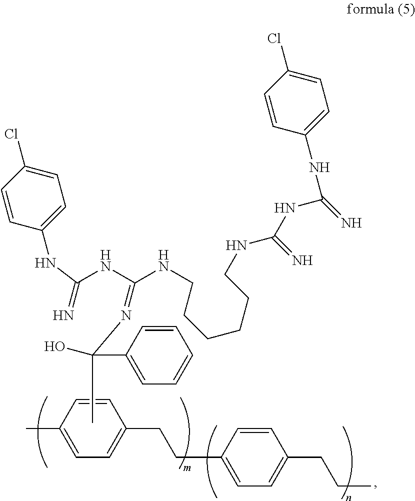

in formula (5), m and n each independently represents an integer ranging from 1 to 150.

The anti-microbial modification method of the invention includes: coating a benzoyl-containing photoinitiator on a surface of a substrate; and bonding a compound represented by formula (1) with the benzoyl-containing photoinitiator via a photoreaction,

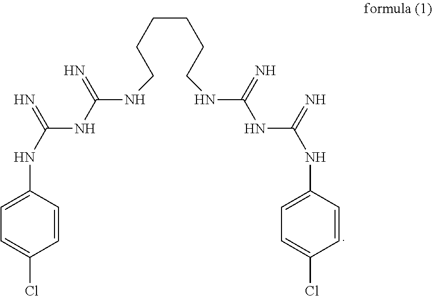 [SMILES: N=C(NCCCCCCNC(=N)NC(=N)Nc1ccc(Cl)cc1)NC(=N)Nc1ccc(Cl)cc1]

In yet another embodiment of the invention, the bonding is a chemical covalent bonding.

In yet another embodiment of the invention, the benzoyl-containing photoinitiator is poly(4-benzoyl-p-xylylene-co-p-xylylene).

In yet another embodiment of the invention the step of coating the benzoyl-containing photoinitiator on the surface of the substrate includes: depositing a benzoyl-containing paracyclophane on the surface of the substrate to form poly(4-benzoyl-p-xylylene-co-p-xylylene) via chemical vapor deposition polymerization.

In yet another embodiment of the invention, poly(4-benzoyl-p-xylylene-co-p-xylylene) is represented by formula (3):

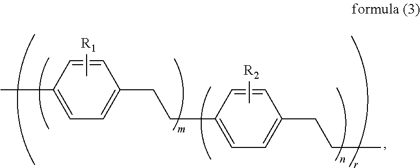

in formula (3), R₁ is a benzoyl group, R₂ is hydrogen or a benzoyl group, m and n each independently represents an integer ranging from 1 to 150, and r is an integer ranging from 1 to 5000.

In yet another embodiment of the invention, the benzoyl-containing paracyclophane is represented by formula (4):

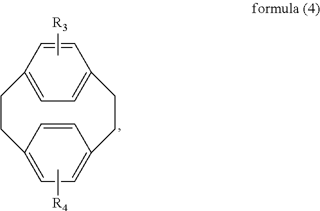

in formula (4), R₃ is a benzoyl group, R₄ is hydrogen or a benzoyl group.

In yet another embodiment of the invention, during the chemical vapor deposition polymerization, the substrate is in a state of rotation.

In yet another embodiment of the invention, a material of the substrate comprises stainless steel, titanium alloy, polymethyl methacrylate (PMMA), polyether ether ketone (PEEK) or polystyrene.

In yet another embodiment of the invention, a wavelength of irradiation light of the photoreaction ranges from 350 nm to 380 nm.

In yet another embodiment of the invention, an irradiation time of irradiation light of the photoreaction ranges from 5 minutes to 120 minutes.

In yet another embodiment of the invention, a light intensity of irradiation light of the photoreaction ranges from 50 mW/cm² to 10000 mW/cm².

In view of the above, the anti-microbial modified material and the anti-microbial modification method of the invention, instead of targeting specific materials, can be applied to various types of common biomedical materials, and do not require the high temperature environment, metal catalyst, toxic solvent etc. for anti-microbial surface modification. Moreover, the anti-microbial substances are covalently bonded to the surface of the substrate after the anti-microbial surface modification, and the anti-microbial substances are not likely to be released to the nearby environment, thus preventing the occurrence of toxic stimulation and allergic reaction in the body.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a flow chart illustrating steps of an anti-microbial modification method according to an embodiment of the invention.

FIG. 1B is a schematic diagram illustrating an anti-microbial modification method according to an embodiment of the invention.

FIG. 2 is an infrared reflection absorption spectrogram obtained in example 2.

FIG. 3 is an X-ray photoelectron spectrum obtained in example 3.

FIG. 4 are fluorescence microscope photos of live/dead cell staining results observed in example 4, wherein (A) is a titanium substrate, (B) is a PEEK substrate, and the fluorescence signal is all green (represents living cells) in (A) and (B). (C) is an anti-microbial modified PEEK substrate, and (D) is an anti-microbial modified titanium substrate, and the fluorescence signal is all red (represents dead cells) and not any living cell was observed in (C) and (D).

FIG. 5 is a histogram illustrated according to example 5 for demonstrating relationships between formation densities of biofilms and substrates.

FIG. 6 are scanning electron microscope photos of biofilm results observed in example 6, wherein (A) is a titanium substrate, (B) is a PEEK substrate, (C) is an anti-microbial modified titanium substrate, and (D) is an anti-microbial modified PEEK substrate.

FIG. 7 shows the results of the antibacterial assay of the blank substrate and the substrates coated with the modified material when exposed to the environment with Enterobacter cloacae for 9 hours at 37° C.

FIG. 8 shows the results of the antibacterial assay of the blank substrate and the substrates coated with the modified material when exposed to the environment with Enterococcus faecalis for 9 hours at 37° C.

### DESCRIPTION OF THE EMBODIMENTS

The following examples and experimental examples are provided to further illustrate various embodiments of the invention. In the present disclosure, the term “step” does not merely indicate an independent step, even in situations of unable to be explicitly distinguish with other steps, as long as the desired effect or purpose of the step is achieved, then they still fall within the scope of the term.

In addition, in the present disclosure, chemical structures of the compounds are sometimes represented using the skeleton formula. This type of representation may omit carbon, hydrogen and carbon-hydrogen bond. Certainly, for structural formulas drawn with clear functional groups, the illustration prevails.

Moreover, in the present disclosure, the ranges represented by “one value to another value” include the values recorded at before and after respectively as the minimum value and the maximum value of each range, so that enumeration of all the values in the range can be avoided throughout the present disclosure. Therefore, descriptions regarding a particular numerical range are intended to encompass any numerical value within the numerical range and any smaller numerical range defined by the numerical values within the numerical range, as if such numerical value and smaller numerical range are expressly described in the disclosure.

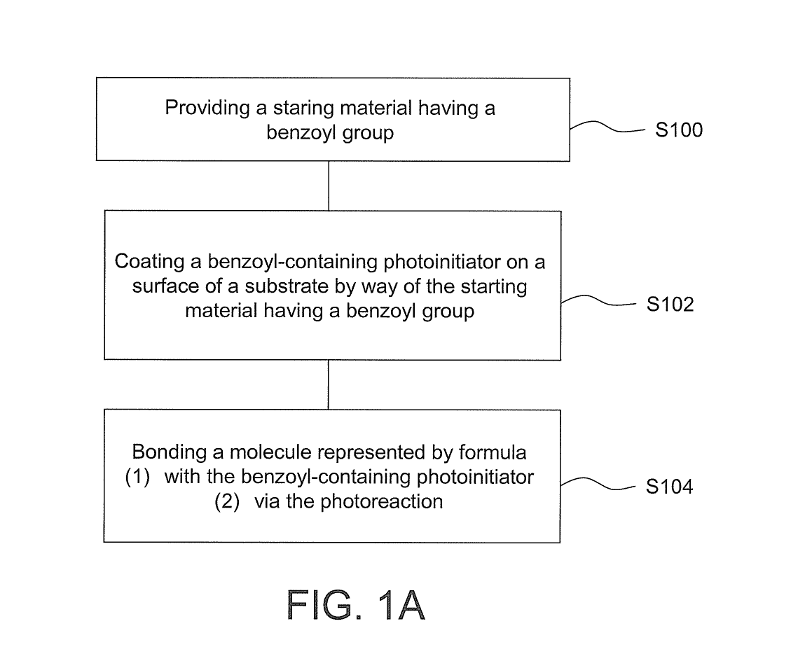

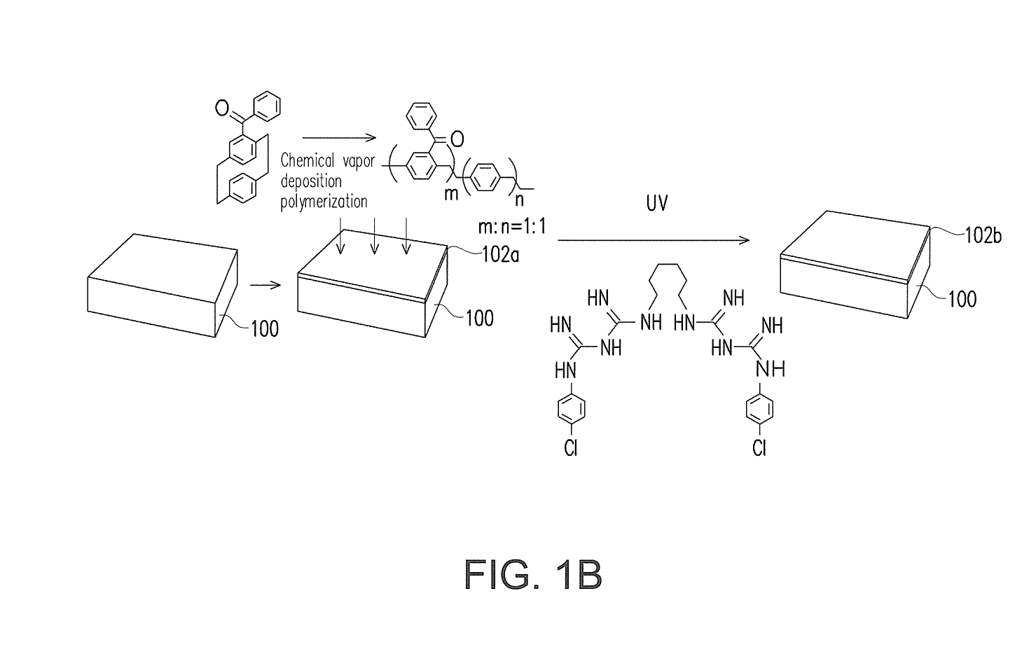

FIG. 1A is a flow chart illustrating steps of an anti-microbial modification method according to an embodiment of the invention. FIG. 1B is a schematic diagram illustrating the reactions for an anti-microbial modification method according to an embodiment of the invention.

Firstly, referring to step S100 of FIG. 1A and FIG. 1B, a staring material having a benzoyl group is provided. The starting material having a benzoyl group may be synthesized by the user or obtained commercially. In the present disclosure, the “benzoyl group” is represented by formula (a),

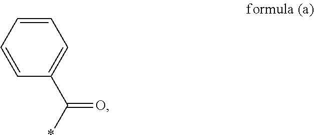 [SMILES: *C(=O)c1ccccc1]

in formula (a), “*” represents a bonding site.

In an embodiment, the starting material having a benzoyl group, for example, is a benzoyl-containing paracyclophane. More specifically, the benzoyl-containing paracyclophane, for example, is represented by formula (4):

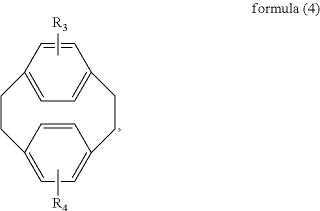

in formula (4), R₃ is a benzoyl group, R₄ is hydrogen or a benzoyl group.

In an embodiment, the starting material having a benzoyl group, for example, is represented by formula (4-1):

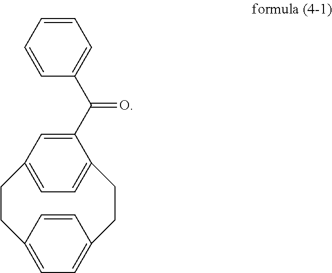 [SMILES: O=C(c1ccccc1)c1cc2ccc1CCc1ccc(cc1)CC2]

Next, referring to step S102 of FIG. 1A and FIG. 1B, a benzoyl-containing photoinitiator is coated onto a surface of the substrate 100 by way of the starting material having a benzoyl group, so as to finial a coating film 102a on the substrate 100.

In an embodiment, the material of the substrate 100, for example, is a metal material or a polymer material. More specifically, the metal material is made of, for example, stainless steel (SS) or a titanium alloy (e.g., Ti₆Al₄V); the polymer material, for example, includes polymethyl methacrylate (PMMA), polyether ether ketone (PEEK) or polystyrene (PS).

In an embodiment, the substrate 100 itself, for example, is in a form of a microcolloid, a stent or a microfluidic device, and may be used as various types of biomedical materials (such as bio-catheter, a heart stent, a pacemaker and so forth).

In an embodiment, a method for coating the benzoyl-containing photoinitiator on the surface of the substrate 100 is performed, for example, through a chemical vapor deposition polymerization, namely, by chemical vapor depositing the benzoyl-containing paracyclophane on the surface of the substrate to polymerize poly(4-benzoyl-p-xylylene-co-p-xylylene). Parylene is certified by US Food and Drug Administration (FDA) and may, for example, be used as a coating film in medical equipments such as bio-catheters, heart stents, pacemakers and so forth. In the present embodiment, attributable to the characteristics of the chemical vapor deposition, a nanoscale film without pinhole may be prepared and may be uniformly deposited on a variety of substrates, which are made of different materials and in different shapes, without requiring any solvent, catalyst or initiator.

In an embodiment, the chemical vapor deposition polymerization is, for example, performed in a deposition chamber, and the starting material having a benzoyl group is copolymerized onto the surface of the substrate to form the benzoyl-containing photoinitiator. In the present embodiment, before feeding the starting material into the deposition chamber, a pre-treatment may be performed depending on the requirements of the manufacturing processes. The pre-treatment, for example, is to sublimate the starting material as the vapor and then to pyrolyze the polymer into monomers. The approach of the pre-treatment, for example, is to firstly perform sublimation in a sublimation zone with specific temperature and pressure conditions, and then to perform pyrolysis in a pyrolysis zone. A temperature for performing the sublimation, for example, ranges from 80° C. to 200° C., and preferably from 100° C. to 150° C. A temperature of the pyrolysis zone, for example, is adjusted to range from 550° C. to 850° C., and preferably from 790° C. to 810° C.

In an embodiment, a pressure for performing the chemical vapor deposition polymerization, for example, ranges from 10 mTorr to 300 mTorr, and a deposition rate thereof, for example, ranges from 0.2 Å/s to 0.8 Å/s.

In an embodiment, during the process of the chemical vapor deposition polymerization, the substrate 100 is being rotated (in a state of rotation), for example. Namely, when performing the chemical vapor deposition polymerization, the substrate, for example, is rotated with an angular velocity, so as to ensure that the benzoyl-containing photoinitiator is uniformly coated onto the surface of the substrate. The approach of rotating the substrate, for example, is to dispose the substrate on a support member and rotate the support member. The rotational speed is not particularly limited and may be adjusted depending on process needs.

In an embodiment, during the process of the chemical vapor deposition polymerization, a temperature of the substrate, for example, is set to be −30° C. to 40° C., preferably 0° C. to 30° C., and more preferably 5° C. to 25° C.

In an embodiment, the benzoyl-containing photoinitiator may, for example, be poly(4-benzoyl-p-xylylene-co-p-xylylene).

In an embodiment, poly(4-benzoyl-p-xylylene-co-p-xylylene), for example, is represented by formula (3):

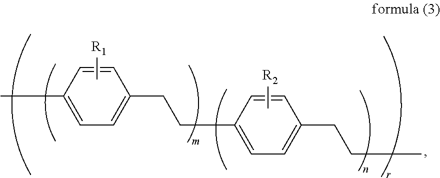

in formula (3), R₁ is a benzoyl group, R₂ is hydrogen or a benzoyl group, m and n each independently is an integer ranging from 1 to 150, and r is an integer ranging from 1 to 5000.

The polymer represented by the formula (3) is only represented with a general formula, and is not intended to limit the order of arrangement of each polymerized monomer.

In an embodiment, in formula (3), m:n=1:1.

Furthermore, in the present disclosure, terms such as m and n “each independently” indicate that m and n may be the same as or different from each other. Moreover, when a bonding site of a substituent is not designated to a specific bonding site on the ring, it indicates that the bonding site of the substituent may be any bondable site on the ring. For instance, in formula (3), a bonding site of a substituent R₁ may be any bondable site on a benzene ring.

In an embodiment, poly(4-benzoyl-p-xylylene-co-p-xylylene), for example, is represented by formula (3-1):

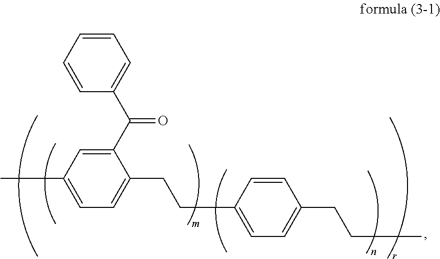

in formula (3-1), m and n each independently is an integer ranging from 1 to 150, and r is an integer ranging from 1 to 5000. The polymer represented by formula (3-1) may be used for a photoreactive p-xylylene coating film, and photochemical activity of the side-chain benzoyl group of the coating film may be exited by the photoreaction to produce free radical(s) at the location of ketone group.

Furthermore, referring to step S104 of FIG. 1A and FIG. 1B, the compound represented by formula (1) is bonded with the benzoyl-containing photoinitiator via the photoreaction, so as to modify the coating film 102a, thereby forming a modified coating 102b,

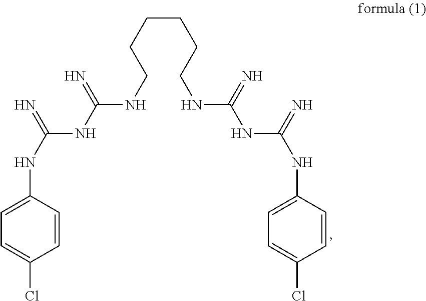

wherein, the compound represented by formula (1) has a very potent antibacterial effect on gram-positive bacteria, gram-negative bacteria or fungi, for instance. The mechanism of the bactericidal effect is to utilize attraction between the positive charges carried by an amino group and the negative charges carried by a phospholipid layer of a bacterial cytoplasmic membrane to destroy the permeable barrier of a plasma membrane.

In an embodiment, the bonding of the compound represented by formula (1) and the benzoyl-containing photoinitiator, for example, is chemical covalent bonding. More specifically, at least one NH in the compound represented by formula (1) a carbonyl group in the benzoyl group. In another embodiment, at least one CH-bond in the compound represented by formula (1) is chemical covalently bonded with a carbonyl group in the benzoyl group.

Namely, the benzoyl-containing photoinitiator used for forming the substrate coating film is bonded with the compound represented by formula (1) through a stable covalent bond, and no anti-microbial substance would be released from the substrate surface. The substrate surface that is modified for anti-microbial effects does not induce cell toxicity. And, by fixing the compound represented by formula (1) to the benzoyl-containing photoinitiator as the substrate coating film, an antibacterial functionality may be imparted for the coating film, thereby achieving the purpose of anti-microbial surface modification.

In an embodiment, a wavelength of irradiation light of the photoreaction ranges from 350 nm to 380 nm.

In an embodiment, an irradiation time of irradiation light of the photoreaction ranges from 5 minutes to 120 minutes.

In an embodiment, a light intensity of irradiation light of the photoreaction ranges from 50 mW/cm² to 10000 mW/cm².

In another embodiment of the invention, an anti-microbial modified material is provided by a bonding of the compound represented by formula (1) with the benzoyl-containing photoinitiator via the photoreaction,

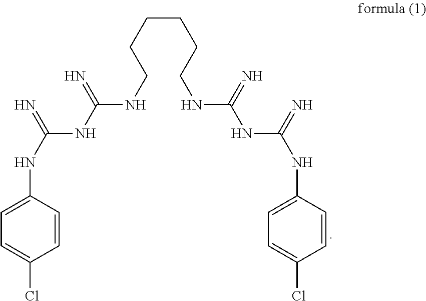 [SMILES: N=C(NCCCCCCNC(=N)NC(=N)Nc1ccc(Cl)cc1)NC(=N)Nc1ccc(Cl)cc1]

Descriptions regarding the photoreaction, the method for bonding the compound represented by formula (1) with the benzoyl-containing photoinitiator and the benzoyl-containing photoinitiator mentioned herein may be referred back to the previous embodiment(s), and will not to be repeated.

In yet another embodiment of the invention, an anti-microbial modified material is provided and includes a structural unit represented by formula (2):

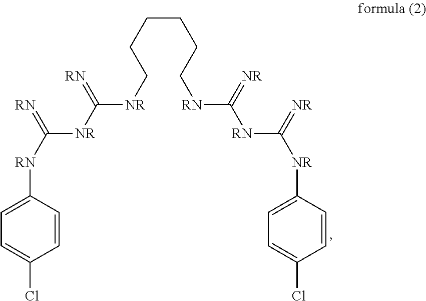

in formula (2), R may each independently be hydrogen or —C(—OH)(-Ph)-, and at least one R is —C(—OH)(-Ph)-.

In the present disclosure, “-Ph” represents a phenyl group, namely, it is generally —C6H5.

In another embodiment, at least one R in formula (2) is hydrogen.

In yet another embodiment, the anti-microbial modified material include a structural unit represented by formula (5):

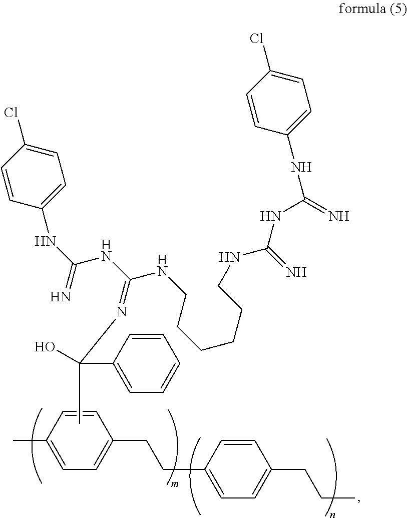

in formula (5), m and n each independently is an integer ranging from 1 to 150.

In the following, more specific descriptions regarding the invention are provided through using one synthesis example and five experimental examples, but the invention are not limited to these examples.

### Example 1

4-benzoyl-[2,2]paracyclophane is used as the starting material, and the chemical vapor deposition polymerization is performed with approximately 50 mg of the starting material. In detail, a chemical vapor deposition system having a sublimation zone, a pyrolysis zone and a deposition chamber is used, and operation steps are described as follow.

Firstly, the starting material is fed into the sublimation zone of about 125° C. to perform sublimation, then fed into the pyrolysis zone at about 810° C. to perform pyrolysis, and finally deposited on the substrate in the deposition chamber by chemical vapor deposition, so as to polymerize poly(4-benzoyl-p-xylylene-co-p-xylylene). When performing the chemical vapor deposition, a temperature of the substrate is controlled at 20° C. and a rotational speed thereof is 3 rpm/min, and the deposition chamber wall is controlled at 100° C. so as to avoid residue precipitation. Moreover, the chemical vapor deposition polymerization is performed at a pressure of 75 mTorr and a deposition rate of 0.5 Å/s.

Then, by irradiating the polymer poly(4-benzoyl-p-xylylene-co-p-xylylene) that is used as a substrate coating film with 365 nm ultraviolet light, the compound represented by formula (1) is fixed onto a surface of the coating film,

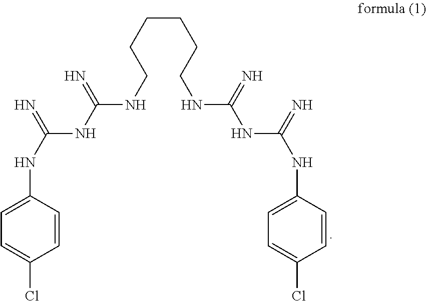 [SMILES: N=C(NCCCCCCNC(=N)NC(=N)Nc1ccc(Cl)cc1)NC(=N)Nc1ccc(Cl)cc1]

In the following, the poly(4-benzoyl-p-xylylene-co-p-xylylene) coating film fixed with the compound represented by formula (1) is referred to as a modified coating film.

### Example 2

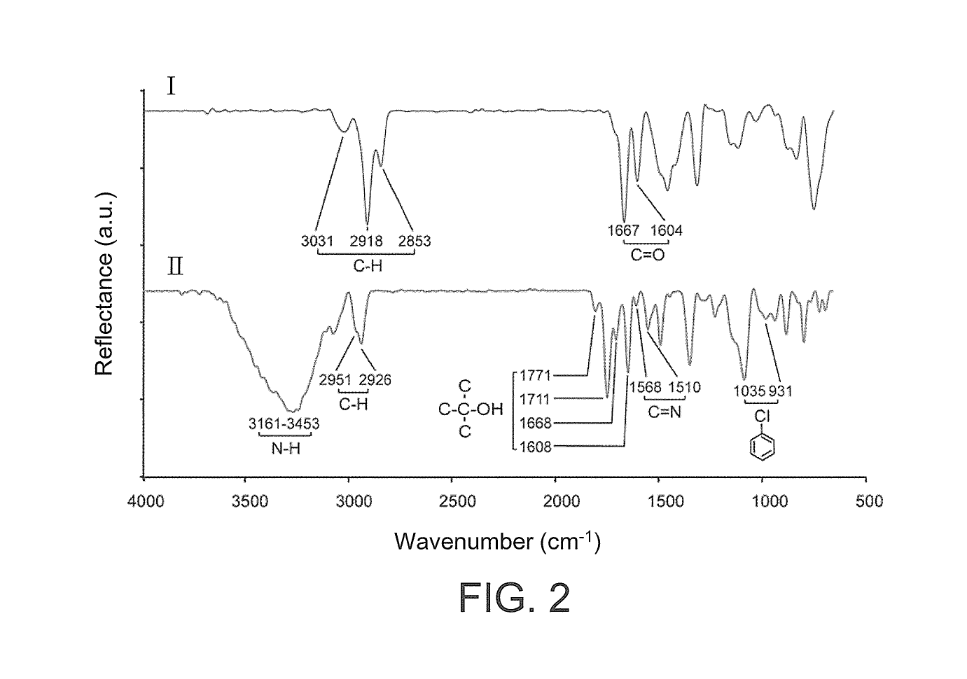

The modified coating film (II in FIG. 2) is examined by an infrared reflection absorption spectroscopy (IRRAS) and then compared with the spectrum of the polymer poly(4-benzoyl-p-xylylene-co-p-xylylene) (I in FIG. 2).

It can clearly be verified from FIG. 2 that the modified coating film is certainly a coating film of poly(4-benzoyl-p-xylylene-co-p-xylylene) bonded with the compound represented by formula (1).

### Example 3

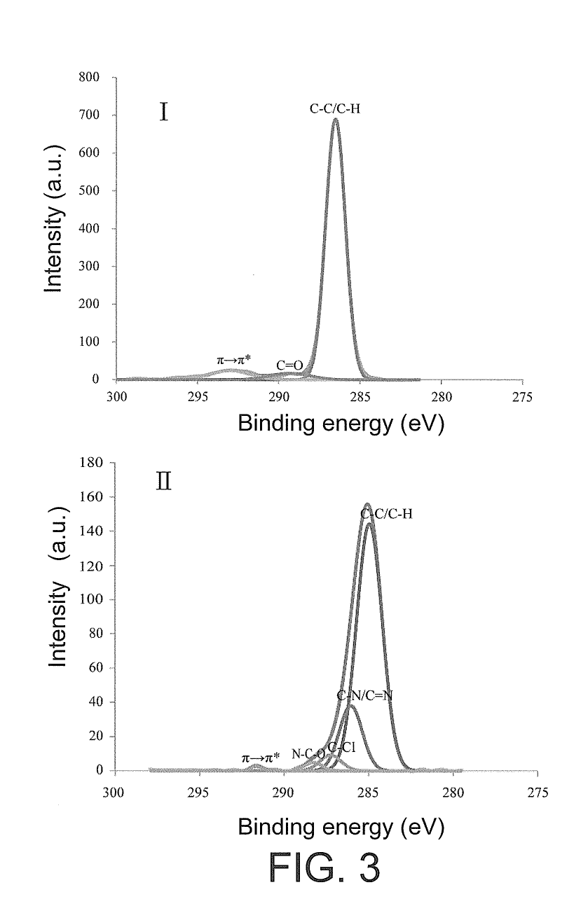

The structural unit shown in formula (3-2) is examined by an X-ray photoelectron spectroscopy, and the results are as shown in (I) of FIG. 3 and in Table 1,

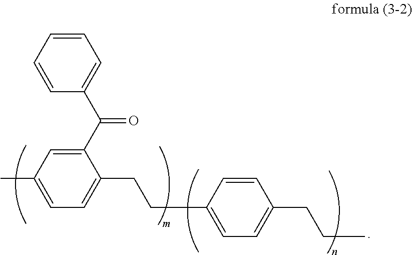

TABLE 1

| Chemical | Binding energy | Experimental value | Theoretical value |
|---|---|---|---|
| state/Element | (eV) | (concentration %) | (concentration %) |
| C—C/C—H | 285.0 | 89.7 | 95.7 |
| C═O | 287.8 | 4.3 | 4.3 |
| π→π* | 291.4 | 6.1 | — |

The structural unit shown in formula (5) is examined by the X-ray photoelectron spectroscopy, and results are as shown in (II) of FIG. 3 and in Table 2,

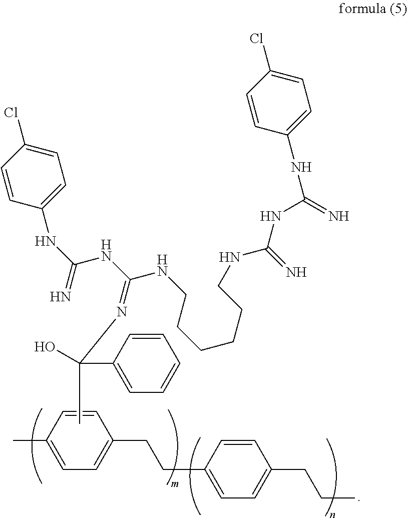

TABLE 2

| Chemical | Binding energy | Experimental value | Theoretical value |
|---|---|---|---|
| state/Element | (eV) | (concentration %) | (concentration %) |
| C—C/C—H | 285.0 | 75.7 | 75.6 |
| C—N/C═N | 286.1 | 17.8 | 17.8 |
| C—Cl | 287.3 | 4.0 | 4.4 |
| N—C—O | 288.3 | 1.8 | 2.2 |
| π→π* | 291.6 | 0.7 | — |

Referring to Table 1 and Table 2, by comparing the obtained experimental values with the theoretical values, it is noted that the results are substantially consistent. The chemical structure obtained by the bonding of poly(4-benzoyl-p-xylylene-co-p-xylylene) with the compound represented by formula (1) may also be further verified.

### Example 4

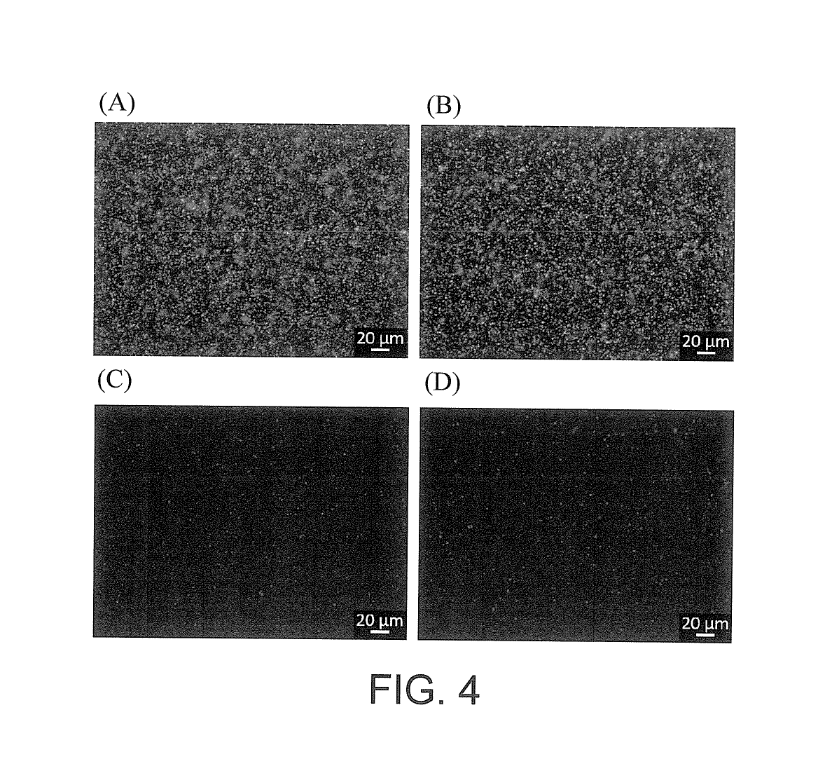

At 37° C., after the titanium alloy substrate and the PEEK substrate that are uniformly coated with the modified coating film and the titanium alloy substrate and the PEEK substrate that are not coated with the modified coating film are respectively exposed to the environment with pseudomonas aeruginosa for 16 hours, the substrates are observed by fluorescence microscopy to obtain the alive/dead cell staining results (color green represents alive cells and color red represents dead cells). The results are as shown in FIG. 4 and are used to evaluate anti-microbial effects of the modified coating film.

In FIG. 4, (A) is the titanium substrate, (B) is the PEEK substrate, (C) is the anti-microbial modified PEEK substrate, and (D) is the anti-microbial modified titanium substrate.

According to FIG. 4, it is apparent that the anti-microbial modified substrates have excellent antibacterial capabilities. Namely, the benzoyl-containing coating film bonded with the compound represented by formula (1) achieves an excellent antibacterial capability. Also, it verifies that the material or method of this invention may be applied to a variety of common biomedical materials.

### Example 5

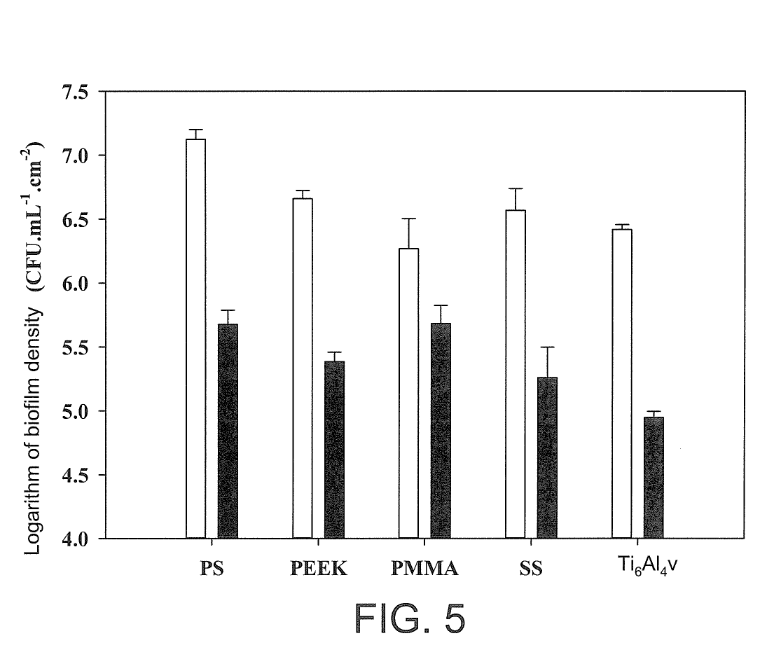

After exposing various substrates under the environment with pseudomonas aeruginosa for 24 hours, pseudomonas aeruginosa colonies formed on the substrates that are coated with/without the modified coating film are directly counted and the results are shown in FIG. 5. In FIG. 5, the white bars represent the results of the substrates not coated with the modified coating film and the black bars represent the results of the substrates coated with the modified coating film. The results indicate that the formation of the biofilm is drastically reduced by coating with the modified coating film. Also, it verifies that the material or method of this invention may be applied to a variety of common biomedical materials.

### Example 6

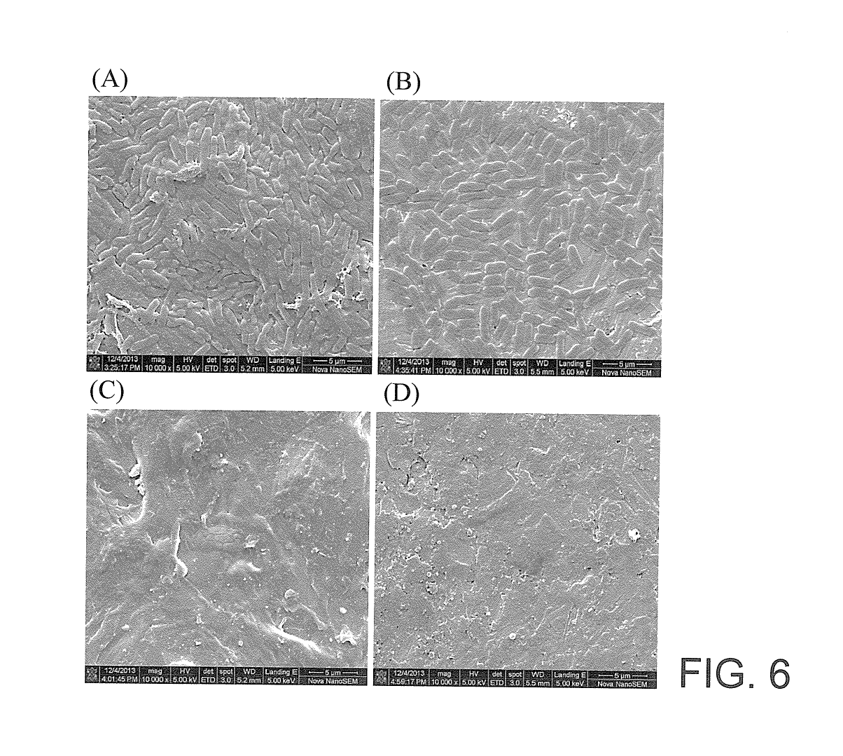

After the titanium alloy substrate and the PEEK substrate that are uniformly coated with the modified coating film and the titanium alloy substrate and the PEEK substrate that are not coated with the modified coating film are respectively exposed to the environment with pseudomonas aeruginosa for 4 hours, the substrates are observed by a scanning electron microscope (SEM) and the results are as shown in FIG. 6.

In FIG. 6, (A) is the titanium substrate. (B) is the PEEK substrate, (C) is the anti-microbial modified titanium substrate, and (D) is the anti-microbial modified PEEK substrate.

According to FIG. 6, it is verified that the substrates coated with the modified coating film have excellent antibacterial capabilities. Namely, the benzoyl-containing coating film bonded with the compound represented by formula (1) achieves an excellent antibacterial capability.

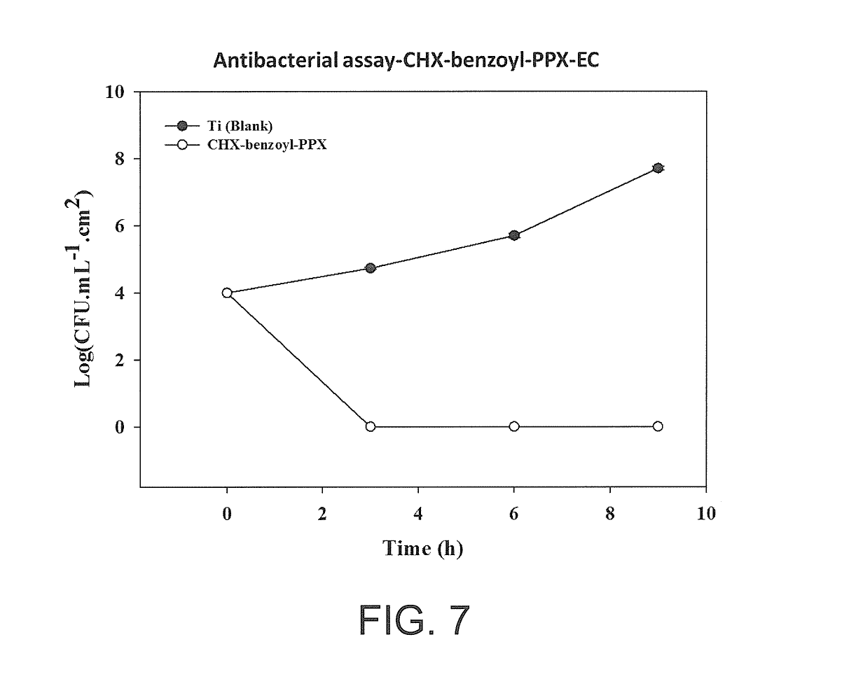

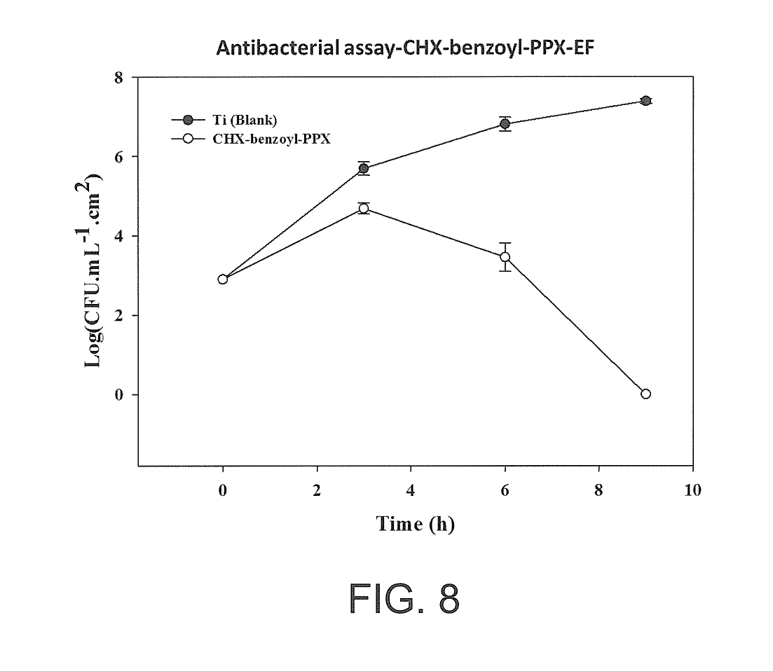

After the titanium alloy substrates were uniformly coated with the modified material (Chlorohexidine-benzoyl-Parylene; CHX-benzoyl-PPX), the coated substrate and uncoated substrate (blank Ti substrate) were exposed to the environment either with Enterobacter cloacae (denoted as EC) or Enterococcus faecalis (denoted as EF) for 9 hours at 37° C. for the antibacterial assay. The results of the antibacterial assay were shown in FIG. 7 and FIG. 8, and the strong bactericidal ability of the modified materials was proven.

In summary, the anti-microbial modified material and the anti-microbial modification method of the invention may be applied to a variety of substrates to endow the antibacterial functionality. Since the compound being used as the anti-microbial substance and represented by formula (1) is fixed onto the substrate via a stable covalent bond, the anti-microbial substance is unlikely to be released to the nearby environment. In addition, the anti-microbial modified substrate surface does not have cell toxicity. Moreover, the anti-microbial modification method of the invention and the anti-microbial modified material prepared thereby have strong bactericidal abilities, by diminishing the formation of the biofilm. Furthermore, the reaction conditions for performing the anti-microbial modification method are simple, and may be performed under the conditions of the room temperature and normal pressure and/or with the presence of oxygen and water to achieve fast response and reaction specificity, without requiring the addition of metal catalysts or toxic solvents.

In addition, the anti-microbial modification method provided by the invention is not complicated and may be compatible with different biomedical materials or biomedical equipments.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An anti-microbial modified material, obtained by a bonding of a compound represented by formula (1) with a benzoyl-containing photoinitiator via a photoreaction,

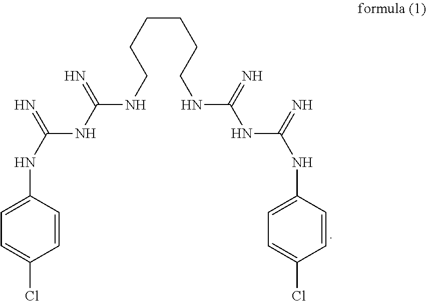 [SMILES: N=C(NCCCCCCNC(=N)NC(=N)Nc1ccc(Cl)cc1)NC(=N)Nc1ccc(Cl)cc1]

2. The anti-microbial modified material as recited in claim 1, wherein the benzoyl-containing photoinitiator comprises poly(4-benzoyl-p-xylylene-co-p-xylylene).

3. The anti-microbial modified material as recited in claim 1, wherein the bonding is chemical covalent bonding.

4. The anti-microbial modified material as recited in claim 1, wherein a wavelength of irradiation light of the photoreaction ranges from 350 nm to 380 nm.

5. The anti-microbial modified material as recited in claim 4, wherein an irradiation time of irradiation light of the photoreaction ranges from 5 minutes to 120 minutes.

6. The anti-microbial modified material as recited in claim 4, wherein a light intensity of irradiation light of the photoreaction ranges from 50 mW/cm² to 10000 mW/cm².

7. An anti-microbial modification method, comprising:
coating a benzoyl-containing photoinitiator on a surface of a substrate; and
bonding a compound represented by formula (1) with the benzoyl-containing photoinitiator via a photoreaction,

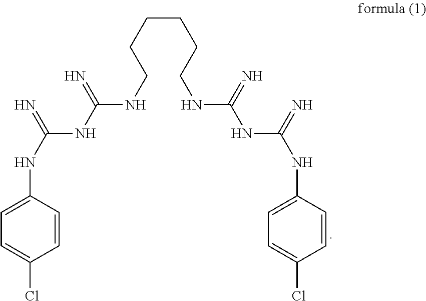 [SMILES: N=C(NCCCCCCNC(=N)NC(=N)Nc1ccc(Cl)cc1)NC(=N)Nc1ccc(Cl)cc1]

8. The anti-microbial modification method as recited in claim 7, wherein the bonding is chemical covalent bonding.

9. The anti-microbial modification method as recited in claim 7, wherein the benzoyl-containing photoinitiator is poly(4-benzoyl-p-xylylene-co-p-xylylene).

10. The anti-microbial modification method as recited in claim 9, wherein the step of coating the benzoyl-containing photoinitiator on the surface of the substrate comprises:
depositing a benzoyl-containing paracyclophane on the surface of the substrate to form poly(4-benzoyl-p-xylylene-co-p-xylylene) via chemical vapor deposition polymerization.

11. The anti-microbial modification method as recited in claim 10, wherein poly(4-benzoyl-p-xylylene-co-p-xylylene) is represented by formula (3): 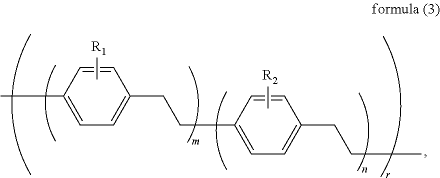
in formula (3), R₁ is a benzoyl group, R₂ is hydrogen or a benzoyl group, m and n each independently represents an integer ranging from 1 to 150, and r is an integer ranging from 1 to 5000.

12. The anti-microbial modification method as recited in claim 10, wherein the benzoyl-containing paracyclophane is represented by formula (4): 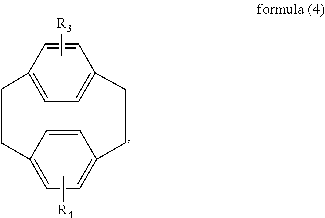
in formula (4), R₃ is a benzoyl group, and R₄ is hydrogen or a benzoyl group.

13. The anti-microbial modification method as recited in claim 10, wherein during performing the chemical vapor deposition polymerization, the substrate is in a state of rotation.

14. The anti-microbial modification method as recited in claim 7, wherein a material of the substrate comprises stainless steel, titanium alloys, polymethyl methacrylate, polyether ether ketone or polystyrene.

15. The anti-microbial modification method as recited in claim 7, wherein a wavelength of irradiation light of the photoreaction ranges from 350 nm to 380 nm.

16. The anti-microbial modification method as recited in claim 15, wherein an irradiation time of irradiation light of the photoreaction ranges from 5 minutes to 120 minutes.

17. The anti-microbial modification method as recited in claim 15, wherein a light intensity of irradiation light of the photoreaction ranges from 50 mW/cm² to 10000 mW/cm².

18. An anti-microbial modified material, comprising a structural unit represented by formula (2): 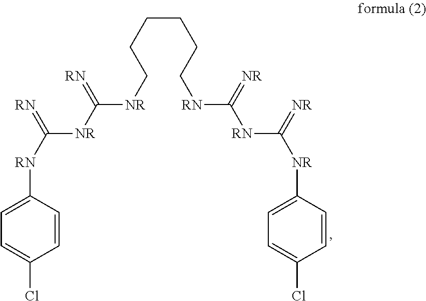
in formula (2), R may each independently represents hydrogen or —C(—OH)(-Ph)-, and at least one R is —C(—OH)(-Ph)-.

19. The anti-microbial modified material as recited in claim 18, wherein at least one R in formula (2) is hydrogen.

20. The anti-microbial modified material as recited in claim 18, comprising a structural unit represented by formula (5): 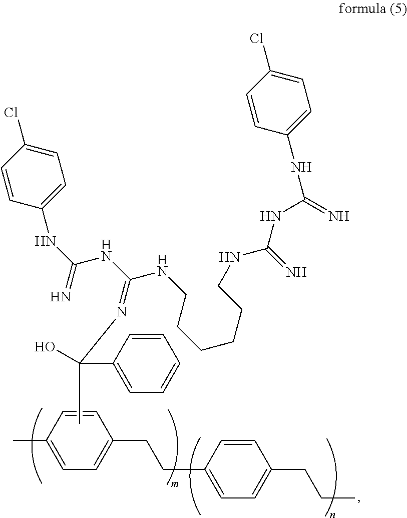
in formula (5), m and n each independently represents an integer ranging from 1 to 150.
